(19) United States
(12) Patent Application Publication
(10) Pub. No.: US 2019/0060038 A1
(43) Pub. Date: Feb. 28, 2019

(54) Apparatus and method for holding and manipulating dental floss

(71) Applicant: Sergiy Lozovsky, Santa Clara, CA (US)

(72) Inventor: Sergiy Lozovsky, Santa Clara, CA (US)

(21) Appl. No.: 15/970,541

(22) Filed: May 3, 2018

Related U.S. Application Data
(60) Provisional application No. 62/550,692, filed on Aug. 27, 2017.

(51) Int. Cl. A61C 15/04

(52) U.S. Cl. CPC A61C 15/046

(57) ABSTRACT

The present invention discloses an apparatus and method for holding and manipulating dental floss for using dental floss more effectively and comfortably.

### CROSS-REFERENCE TO RELATED APPLICATIONS

The present Utility patent application claims priority benefit of the U.S. provisional application for patent Ser. No. 62/550,692 entitled “Apparatus and method for holding and manipulating dental floss” filed Aug. 8, 2017 under 35 U.S.C. 119(e). The contents of this related provisional application are incorporated herein by reference for all purposes to the extent that such subject matter is not inconsistent herewith or limiting hereof.

### INCORPORATION BY REFERENCE OF SEQUENCE LISTING PROVIDED AS A TEXT FILE

Not applicable.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection by the author thereof. The copyright owner has no objection to the facsimile reproduction by anyone of the patent document or patent disclosure for the purposes of referencing as patent prior art, as it appears in the Patent and Trademark Office, patent file or records, but otherwise reserves all copyright rights whatsoever.

### FIELD OF THE INVENTION

The invention relates to oral hygiene, and more particularly to using dental floss more effectively and comfortably.

### BACKGROUND

A typical regimen of oral hygiene includes cleaning easily accessible surfaces of the teeth using a toothbrush and toothpaste, and cleaning the spaces between the teeth with dental floss. A complete program of oral hygiene should include cleaning and stimulation of all of the teeth and gums, including those hard-to-reach surfaces between the teeth, such as those far back in the mouth.

A toothbrush is easy to use for reaching all of the more accessible tooth surfaces. Dental floss, however, can be difficult to hold with enough firmness to maintain a grip while inserting it between the teeth, and then rubbing it against the sides of the teeth. Furthermore, if the floss is held with sufficient firmness to maintain the needed grip, it can press so tightly against one's fingers that it becomes uncomfortable, and can even cut into the flesh and/or interfere with circulation, leaving visible and uncomfortable indentations. If the floss is not held firmly, it will slip between the fingers, and either will not go where it's needed, or will remain stuck between the teeth. These difficulties commonly cause individuals who brush regularly to nevertheless neglect flossing, despite the importance of flossing to oral hygiene.

Several devices intended to make flossing easier and more comfortable to use are known. Some of these devices capture the floss tightly in an essentially rigid section attached to a handle. Such devices cannot be used with the same degree of dexterity that is possible when dental floss is hand-held, and they severely reduce one's ability to use the sense of touch for guiding the dental floss within the mouth. The use of touch to guide dental floss is important due to the relatively inaccessible areas that the floss must reach, and the difficulty of seeing clearly into the mouth, even with the help of a mirror.

Other proposed devices for holding and manipulating dental floss are used by being attached to a finger or a hand, thereby providing for a level of dexterity that is better than a rigid floss holder, but provide considerably less control over the floss then when dental floss is hand-held. These devices also interfere with one's ability to guide the dental floss within the mouth by feel, and they are time consuming and cumbersome to attach and remove. In addition, these devices are too complex and expensive to be treated as disposable, and hence must be thoroughly cleaned after each usage.

### BRIEF SUMMARY OF THE INVENTION

An apparatus for holding and manipulating dental floss is disclosed, together with a method for the usage thereof, that is sufficiently inexpensive, compact, reusable, that enables a user to grip dental floss firmly, easily, and comfortably, while maintaining the dexterity associated with hand-held flossing. The apparatus except of the floss itself stays out of the mouth during the whole flossing procedure.

In one embodiment apparatus includes a pair of reusable handles. The ends of one piece of floss used for the procedure can be securely attached to the handles. Handles are held by palms or fingers. Floss goes over the fingers that a person is using to floss. Usually these are index or middle fingers (guiding fingers).

Handles allow comfortable and secure grip of the floss ends, while a person can apply the similar cleaning technique she is using when flossing without any additional devices. An additional benefit is ability to easily switch fingers that are guiding the floss during the procedure.

One example of the flossing procedure includes getting a piece of floss, attaching one handle to one end of the floss and another handle to another end, holding handles by the palms and/or fingers of both hands, placing floss over index or middle fingers, flossing as usual, disconnecting handles and disposing the used floss. Handles require much less cleaning than devices that are placed in the mouth.

In another embodiment one of the handles can provide floss dispensing feature. Such handle will provide ability to securely retain the floss during flossing procedure on top of the usual floss dispenser functionality (dispensing, cutting and holding the end of floss between flossing procedures). The flossing procedure with such embodiment will include pulling a piece of floss from the handle-dispenser, activate the retainer on the handle, attaching the end of the floss to another handle, holding handles by the palms and/or fingers of both hands, placing floss over index or middle fingers, flossing as usual, disconnecting the handle, activate cutting feature on the handle-dispenser, to cut off the used piece of the floss and disposing the used floss.

Handle grip and the way floss goes over the fingers can change during flossing procedure. For example, some places in the mouth is easier to reach with index fingers and others with a middle finger on one hand and index finger on another, etc.

There may be a feature to attach one handle to another and/or to a floss dispenser for storage and transportation.

There are many well-known ways to implement floss retention feature.

### BRIEF DESCRIPTIONS OF THE DRAWINGS

The disclosed embodiments have other advantages and features which will be more readily apparent from the following detailed description of the invention, when taken in conjunction with the accompanying drawings, in which:

FIG. 1 illustrates a perspective view of the dental floss handles.

FIG. 2 illustrates one possible way of holding the floss handles.

FIG. 3 illustrates one possible way of attaching (tying) the floss to the handle.

### DETAILED DESCRIPTION

The figures and the following description relate to preferred embodiments by way of illustration only. It should be noted that from the following discussion, alternative embodiments of the structures and methods disclosed herein would be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

Example Floss Handle

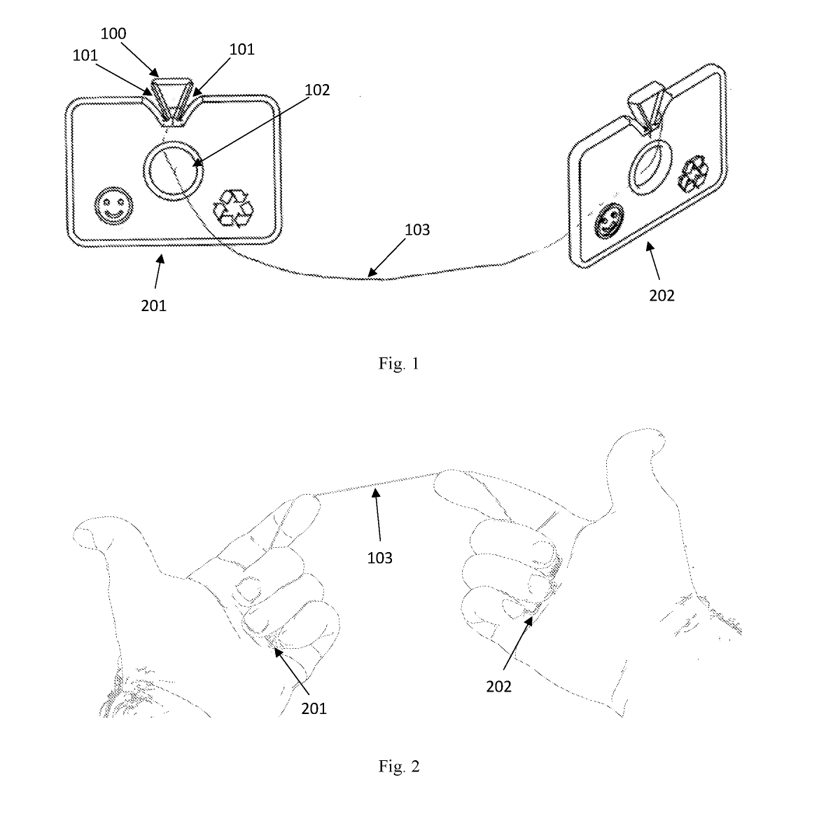

FIG. 1 Illustrates two identical floss handles 201 and 202. Dental floss 103 is attached to the handles. The handle includes a guidance hole 102, floss retainer stem 100 and narrow retainer splits 101.

To provide a secure connection to the handle 201, floss 103 enters the guidance hole 102 and loops around retainer stem 100 through splits 101. Friction between floss and sides of the splits prevents floss from slipping and holds it secure in place. If friction is not enough to secure the floss in place the loops or the knots can be tied at the ends of the floss. A knot would prevent floss from slipping through the split 101. The loop can be put on the retainer stem 100. Guidance hole 102 sets a particular direction for the floss to enter the retainer split even if orientation of the handle changes. Higher tension of the floss pushes it deeper into the split which results in a greater friction and more secure connection. The shape and size of the handle allows comfortable and secure grip by the palms of the hands.

FIG. 2 illustrates one possible way of holding the floss handles 201 and 202 with a floss 103. The handles are held by the palms with the floss going over the index fingers.

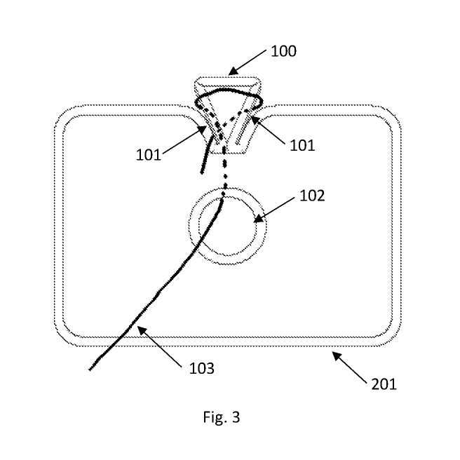

FIG. 3 illustrates one possible way of tying a floss to the handle. This way of tying is simple, uses small amount of floss, secure and easy to untie. To tie the floss in the way presented on FIG. 3: thread the floss 103 through the hole 102, secure the end of the floss in the split 101, make a loop of the floss around the retainer stem 100, pull the long end of the floss to tie everything down.

There can be many different ways to tie the floss to the handle.

A plurality of materials can be used to manufacture the handles: metal, plastic, etc. Material can be sturdy or more flexible as long as secure and comfortable grip is provided.

There can be many other embodiments with different handle shapes and type of retainer. An example of other retainer types: U.S. Pat. Nos. 6,895,977, 9,717,574, 9,936,798, Patent Application 20100018547 and others.

One of the handles can include functionality of a floss dispenser. Current invention includes two handles which stays out of the mouth in a contrast with U.S. Pat. No. 6,895,977 which describes just one handle-dispenser designed to enter a mouth.

1. An apparatus for holding dental floss comprising: two identical handles comfortable for a hand grip. Each handle has a retention feature to which a floss end can be attached. Each end of a floss segment is attached to said handles. Floss goes over the fingers which create required tension and guide the floss between the teeth.

2. The apparatus for holding dental floss of claim 1, further comprising a floss guiding feature keeping the floss position relative to the retention feature.

3. The apparatus for holding dental floss of claim 1, wherein two handles can be connected together for storage or transportation.

4. The apparatus for holding dental floss of claim 1, further comprising a floss dispenser embedded in one of the handles.

5. The apparatus for holding dental floss of claim 2, wherein a floss guiding feature is a hole in the handle.

6. The apparatus for holding dental floss of claim 1, wherein a retention feature is a cut in the handle. When put in the cut the floss end is retained by the friction or by a knot tied at the end of the floss.

7. The apparatus for holding dental floss of claim 1, wherein a retention feature is two cuts in the handle. The floss can be retained by:
friction when floss end is placed in one cut;
friction when floss end is wrapped around the stem created by two cuts;
a knot tied at the end of the floss;
a loop tied at the end of the floss and put on the stem created by two cuts;

8. The apparatus for holding dental floss of claim 7, wherein a stem created by two cuts is extended outside the rest of the handle. The stem helps guiding the floss into the cuts and securing the loop at the end of the floss.
